(19) United States
(12) Patent Application Publication
(10) Pub. No.: US 2014/0186795 A1
(43) Pub. Date: Jul. 3, 2014

(54) DENTAL IMPLANT PICK UP AND DRIVE ASSEMBLY

(71) Applicant: Mao-Sung Huang, Taichung City (TW)

(72) Inventor: Mao-Sung Huang, Taichung City (TW)

(73) Assignee: BIODENTA CORPORATION, New Taipei City (TW)

(21) Appl. No.: 13/731,844

(22) Filed: Dec. 31, 2012

(51) Int. Cl. A61C 8/00

(52) U.S. Cl. CPC A61C 8/0089
USPC 433/141

(57) ABSTRACT

The invention provides a dental implant pick up and drive assembly, comprising a dental implant and a pick up and drive device for picking up the implant and driving it into a patient's jawbone. The dental implant comprises a cavity disposed on one end of the dental implant, a first wall portion in a hexagon shape connected with the cavity, and a threaded portion enclosing the dental implant. The pick up and drive device comprises: a driver head, disposed at an end portion thereof, including a second circumferential wall in a hexagon shape, in which a size of the second circumferential wall is slightly smaller than a size of the first wall portion of the implant for close accommodation when in driving. At least one wall of the second circumferential wall of the driver head has a slant surface for engaging and interfering with the implant when in picking up.

### FIELD OF THE INVENTION

The present invention relates to a dental implant pick up and drive assembly and to a pick up and drive device for use therein.

### DESCRIPTION OF PRIOR ART

In the human's life, the need of installing dental implants is fast increasing. Installation of an implant is proceeded to drive it into a predrilled cavity in a patient's jawbone using a driving tool. Due to that the implant is in general sealed in a sterile package, it is a trend to apply a pick up and drive assembly for accomplishing both functions of picking up and driving the implant in a convenient and security manner. A lot of the tools and implants are developed for such a use.

In the existing art, U.S. Pat. No. 8,029,282 B2 discloses a self-aligning dental component carry and drive assembly, comprising a drive end including four planner drive surfaces, at least one interference surface and a pilot portion, in which the interference surface extends from the proximal end to the distal end of the driver end to enable frictional carrying engagement, while the pilot portion is to enable alignment of the drive surfaces of the end with the at least one surface in the driving recess. Such a structure appears to be rather complicated. In addition, as revealed in the patent, limited deformation will occur in the drive surface because of the softer material of the screw material, rendering the implant not durable. Meanwhile, during pick up, the driver end, usually being made of a hard material of metal, is to directly engage and interfere with the surface(s) within the driving recess of the dental component, usually being made of a soft and expansive material of Titanium or Titanium alloy, the surface(s) of the implant component is easily subject to damage.

Thus, it is desired to develop a dental implant pick up and drive assembly to overcome the above shortcomings.

### SUMMARY OF THE INVENTION

It is an objective of the invention to provide a simple structure of a dental implant pick up and drive assembly capable of directly picking up the implant and driving it into a patient's jawbone in an effective and simple manner.

It is a further objective of the invention to provide a durable dental implant pick up and drive assembly to avoid an implant and/or an abutment (screw) from being damaged during pick up and/or driving of the implant.

It is a still further objective of the invention to provide a dental implant pick up and drive assembly to perform the functions of pick up and drive independently.

To accomplish the above objectives, the invention provides a dental implant pick up and drive assembly, which comprises: a dental implant, comprising a cavity disposed on one end of the dental implant, a first wall portion connected with the cavity, including a cylinder and a first circumferential wall in a hexagon shape encompassed by the cylinder, each wall being in parallel with a central axis of the cavity and having a round shape in a first center portion (abbreviated as a round center portion hereinafter)thereof, and a threaded portion enclosing the dental implant; and a pick up and drive device, comprising: a driver head, disposed at an end portion, including a second circumferential wall in a hexagon shape and each wall being in parallel with a second central axis of the driver head, in which a size of the second circumferential wall is slightly smaller than a size of the first circumferential wall of the first wall portion for close accommodation and at least one wall of the second circumferential wall of the driver head has a slant surface, wherein the slant surface of the at least one wall of the second circumferential wall of the driver head is engaged to interfere with and thus to stick the round center portion of the first circumferential wall of the first wall portion when in pick up.

In the dental implant pick up and drive assembly, the slant surface of the driver head is tapered and becoming thinner in thickness from a side distal from the end portion toward the other side near the end portion for engagement. With such a structure, the driver head is to pick up the implant directly in an effective and simple way.

Further, in the dental implant, a first radial distance between a point of the center portion in a round shape of each of the first circumferential wall and a center of the cavity is larger than a second radial distance between each side of the first circumferential wall and the center of the cavity, in which largeness is depending on an arcuate location on the center portion in a round shape. With such an architecture, because pick up of the implant by the driver head is proceeded in the round portion and not on the hexagon wall of the dental implant, i.e. the sticking point being out of the hexagon wall, the implant will prevent from being damaged and thus being durable in use. Usually, the implant is made from a soft and expansive material, such as Titanium or Titanium alloy.

In addition, to drive the implant by the driver's head, since both are in a hexagon shape, the driving can be proceeded in a close and smooth manner.

Meanwhile, the first circumferential wall in a hexagon shape guides the second circumferential wall in a hexagon shape when inserting the driver head into the cavity, allowing the pick up and drive device to drive the dental implant effectively and simply when in implanting. Besides, an abutment(screw)and/or an abutment connection, which is not an issue addressed by the invention and thus not stated in detail in the specification, will be protected from being damaged during drive of the implant.

In addition, the end portion, including the driver head and the slant surface, is of a one piece design. i.e. both being processed from a cylinder material. As describe above, the invention is capable of independently perform the functions of picking up and driving the dental implant.

### BRIEF DESCRIPTION OF THE DRAWINGS

FIG. 1 shows an overall view of a dental implant and pick up and drive assembly, when being applied for use, in accordance with a preferred embodiment of the invention.

FIG. 2-1 is an elevation view of the pick up and drive device, when viewed from a center axis thereof, in accordance with the preferred embodiment of the invention.

FIG. 2-2 is a side view of an end portion of the pick up and drive device in accordance with a preferred embodiment of the invention.

FIG. 3-1 is an elevation view of the dental implant in accordance to the preferred embodiment of the invention.

FIG. 3-2 is an elevation view of the dental implant, when viewed from a center axis thereof, in accordance the preferred embodiment of the invention.

FIGS. 4-1, 4-2, 4-3 and 4-4 show a section view of a pick up structure in accordance with the preferred embodiment of the invention.

### DETAILED DESCRIPTION OF THE INVENTION

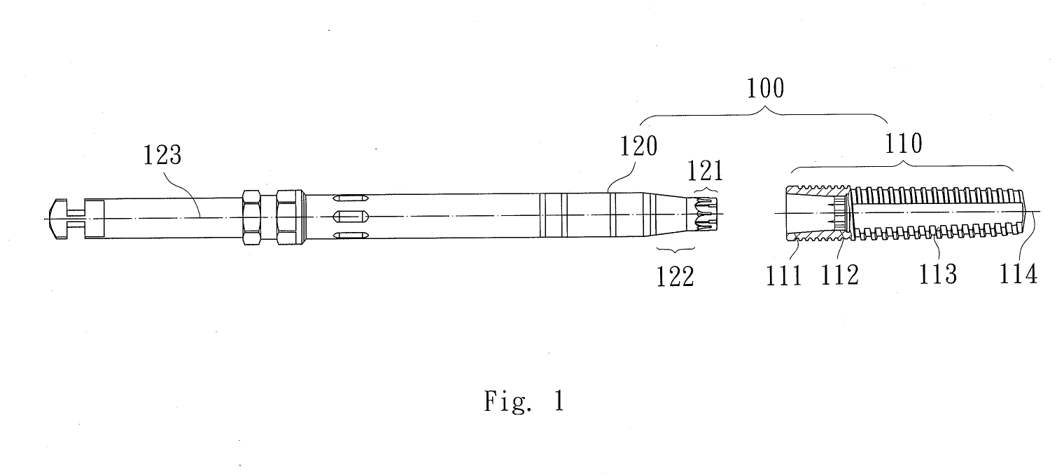

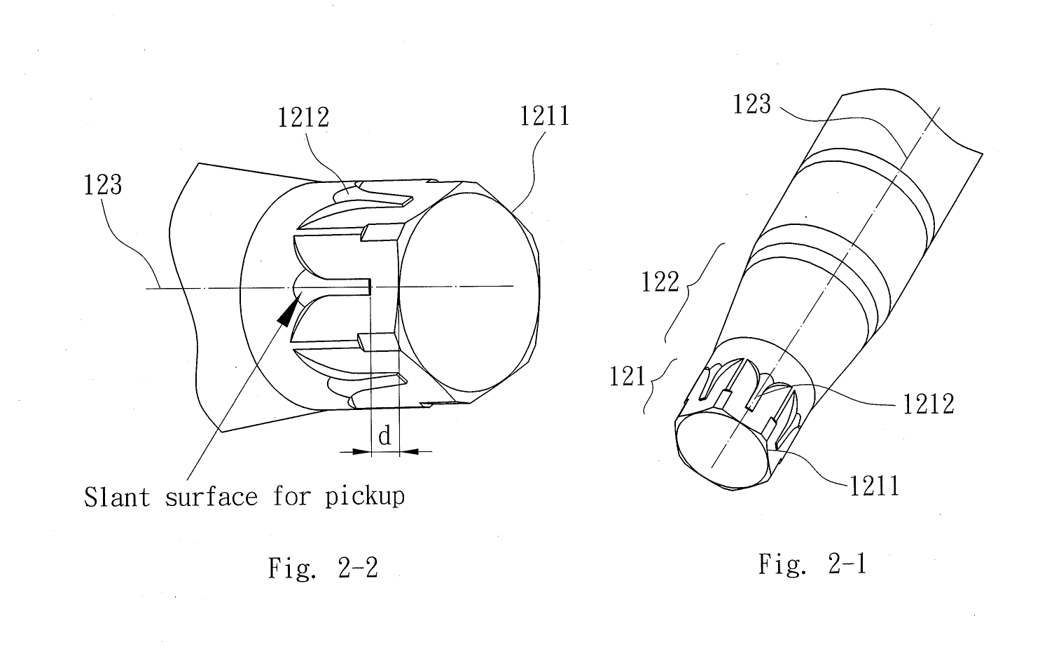

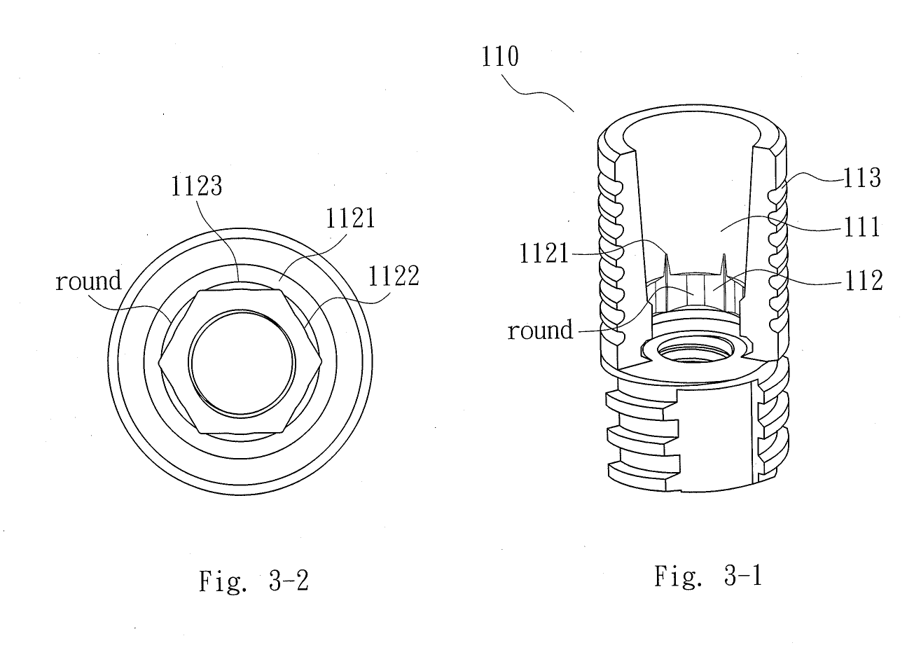

The invention is to provide a dental implant and pick up and drive assembly. Please refer to FIG. 1, illustrating an overall view of a dental implant and pick up and drive assembly 100, when being applied for use, in accordance with a preferred embodiment of the invention, while referring to FIG. 2-1, FIG. 2-2, FIG. 3- 1 and FIG. 3-2. The assembly 100 comprises a dental implant 110, comprising a cavity 111 disposed on one end of the dental implant, a first wall portion 112 connected with the cavity 111, including a cylinder 1121 and a first circumferential wall 1122 in a hexagon shape encompassed by the cylinder 1121, each wall being in parallel with a central axis 114 of the cavity 111 and having a round shape 1123 in a first center portion(round center portion 1123) thereof, and a threaded portion 113 enclosing the dental implant 110; and a pick up and drive device 120, comprising: a driver head 121, disposed at an end portion 122 ,including a second circumferential wall 1211 in a hexagon shape and each wall being in parallel with a second central axis 123 of the driver head, in which the end portion 122 includes the driver head 121 and a connection part as shown in FIG. 1 and a size of the second circumferential wall 1211 is slightly smaller than a size of the first circumferential wall 1122 of the first wall portion 112 for close accommodation and at least one wall of the second circumferential wall 1211 of the driver head 121 has a slant surface 1212, wherein the slant surface 1212 of the at least one wall of the second circumferential wall 1211 of the drive head is engaged to interfere with the round center portion 1123 of the first circumferential wall of the first wall portion when in pick up.

According to an example of the embodiment, the slant surface 1212 of the driver head 121 is tapered and becoming thinner in thickness from a side distal from the end portion 122 toward the other side near the end portion 122 for engagement.

In the dental implant, a first radial distance between a point of the round center portion 1123 of each of the first circumferential wall 1122 and a center of the cavity 111 is larger than a second radial distance between each side of the first circumferential wall 1122 and the center of the cavity 111, in which largeness is depending on an arcuate location on the round center portion 1123.

When in implanting, the first circumferential wall 1122 in a hexagon shape guides the second circumferential wall 1211 in a hexagon shape when inserting the driver head 121 into the cavity 111, allowing the pick up and drive device 120 to drive the dental implant 110.

According to the invention, the end portion 122, including the driver head 121 and its slant surface 1212, is of a one piece design. The slant surface 1212 of the driver head is spaced apart a distance(d) from the other side of the end portion 122 of the at least a wall of the second circumferential wall 1211 to facilitate initial engagement of the slant surface 1212 and the round center portion 1123 of the first circumferential wall.

The slant surface 1212 of the driver head 121 is changeable with respect to its dimension, shape or curvature under a condition of being able to insert and interfere with the round center portion 1123 of the first circumferential wall 1122 of the first wall portion 112 of the dental implant.

Please refer to FIGS. 2-1 and 2-2, while referring to FIGS. 1 and FIGS. 3-1 and 3-2. The invention further provides a driver head 121 for a dental implant pick up and drive assembly 100, in which the assembly 100 comprises: a dental implant 110, including a cavity 111, a first wall portion 112 connected with the cavity 111, including a first circumferential wall 1122 and a threaded portion 113 enclosing the dental implant 110; and a pick up and drive device 120, including a driver head 121.

The driver head 121 is disposed at an end portion 122 of the pick up and drive device 120, comprising: a second circumferential wall 1211 in a hexagon shape and each wall being in parallel with a second central axis 123 of the driver head 121, in which a size of the second circumferential wall 1211 is slightly smaller than a size of the first circumferential wall 1121 of the first wall portion 112 in a hexagon shape for close accommodation and at least one wall of the second circumferential wall 1121 of the driver head 121 has a slant surface 1212.

In the invention, the slant surface 1212 of the at least one wall of the second circumferential wall of the driver head is engaged to interfere with the first wall portion 112 for pick up.

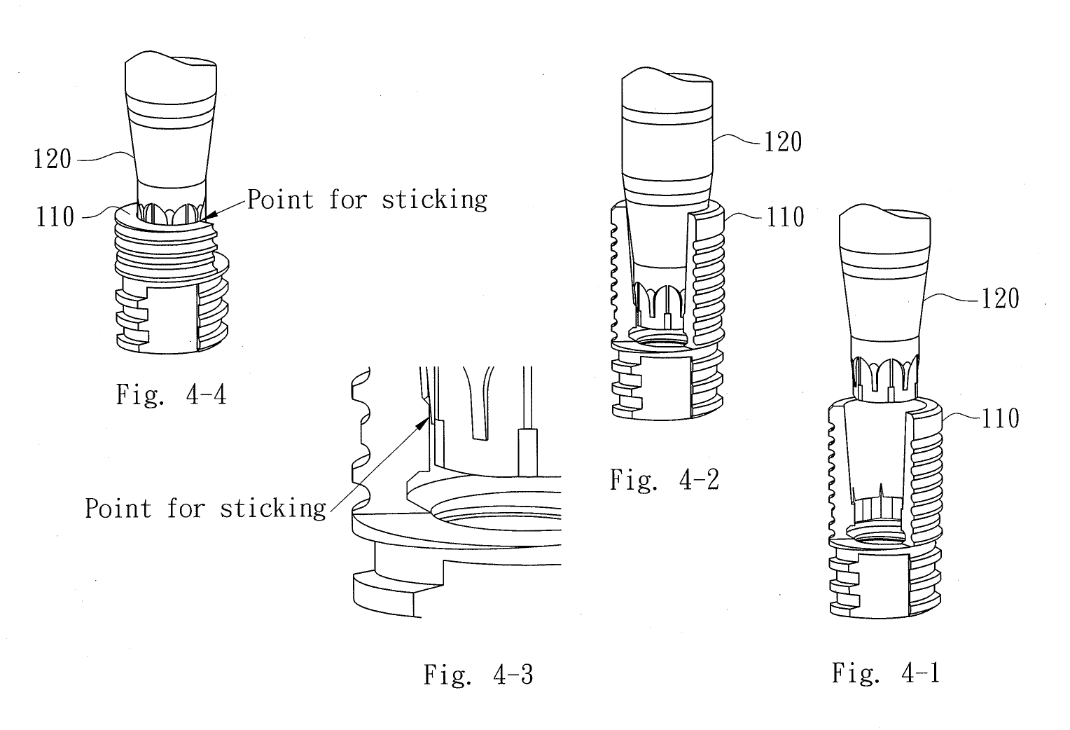

The operation of pick up will described more in detail as below, while referring to FIG. 4. The slant surface 1212 of the driver head 121 is tapered and becoming thinner in thickness from a side distal from the end portion 122 toward the other side near the end portion for engagement.

According to the invention, the end portion 121, including the driver head 121 and the slant surface 1212, is of a one piece design. The slant surface 1212 of the driver head 121 is spaced apart a distance (d) from the other side of the end portion 121 of the at least one wall of the second circumferential wall to facilitate initial engagement of the slant surface 1212 and a round center portion 1123 of the first circumferential wall to facilitate initial engagement of the slant surface 1212 and the first wall portion 112 of the dental implant 110.

In the invention, the slant surface 1212 of the driver head 121 is changeable with respect to its dimension, shape or curvature under a condition of being able to insert and interfere with the first wall portion 112 of the dental implant.

Please refer to FIGS. 4-1, 4-2, 4-3 and 4-4, illustrating a section view of a pick up structure according to the preferred embodiment of the invention. As shown in FIG. 4, while referring to FIGS. 2-1,2-1,3-land 3-2, as the driver head 121 of the pick up and drive device 120 is inserting into the dental implant 110, the slant surface 1212 of the at least one second circumferential wall 1211 of the driver head 121 is engaged and interfere with a round shape 1123 in a first center portion of the first circumferential wall 1122 at a sticking point, which is shown more in detail in FIGS. 4-3 and 4-4.

The foregoing description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments described herein but is to be accorded the widest scope of the following claims consistent with the principles and novel features disclosed herein.

What is claimed is:

1. A dental implant pick up and drive assembly, comprising:
a dental implant, comprising a cavity disposed on one end of the dental implant, a first wall portion connected with the cavity, including a cylinder and a first circumferential wall in a hexagon shape encompassed by the cylinder, each wall being in parallel with a central axis of the cavity and having a round shape in a first center portion thereof, and a threaded portion enclosing the dental implant; and
a pick up and drive device, comprising a driver head, disposed at an end portion, including a second circumferential wall in a hexagon shape and each wall being in parallel with a second central axis of the driver head, in which a size of the second circumferential wall is slightly smaller than a size of the first circumferential wall of the first wall portion for close accommodation and at least one wall of the second circumferential wall of the driver head has a slant surface,
wherein the slant surface of the at least one wall of the second circumferential wall of the drive head is engaged to interfere with the round center portion of the first circumferential wall of the first wall portion when in pick up.

2. A dental implant pick up and drive assembly of claim 1, wherein the slant surface of the driver head is tapered and becoming thinner in thickness from a side distal from the end portion toward the other side near the end portion for engagement.

3. A dental implant pick up and drive assembly of claim 1, wherein a first radial distance between a point of the center portion in a round shape of each of the first circumferential wall and a center of the cavity is larger than a second radial distance between each side of the first circumferential wall and the center of the cavity, in which largeness is depending on an arcuate location on the center portion in a round shape.

4. A dental implant pick up and drive assembly of claim 1, wherein the first circumferential wall in a hexagon shape guides the second circumferential wall in a hexagon shape when inserting the driver head into the cavity, allowing the pick up and drive device to drive the dental implant when in implanting.

5. A dental implant pick up and drive assembly of claim 1, wherein the end portion, including the driver head and the slant surface, is of a one piece design.

6. A dental implant pick up and drive assembly of claim 2, wherein the slant surface of the driver head is spaced apart a distance (d) from the other side of the end portion of the at least a wall of the second circumferential wall to facilitate initial engagement of the slant surface and the round center portion of the first circumferential wall.

7. A dental implant pick up and drive assembly of claim 2, wherein the slant surface of the driver head is changeable with respect to its dimension, shape or curvature under a condition of being able to insert and interfere with the round center portion of the first circumferential wall of the first wall portion of the dental implant.

8. A driver head for a dental implant pick up and drive assembly, the assembly comprising: a dental implant, including a cavity, a first wall portion connected with the cavity, including a first circumferential wall and a threaded portion; and a pick up and drive device, including a driver head, the driver head being disposed at an end portion of the pick up and drive device, comprising: a second circumferential wall in a hexagon shape and each wall being in parallel with a second central axis of the driver head, in which a size of the second circumferential wall is slightly smaller than a size of the first circumferential wall of the first wall portion in a hexagon shape for close accommodation and at least one wall of the second circumferential wall of the driver head has a slant surface,
wherein the slant surface of the at least one wall of the second circumferential wall of the drive head is engaged to interfere with the first wall portion for pick up.

9. A driver head for a dental implant pick and drive assembly of claim 8, wherein the slant surface of the driver head is tapered and becoming thinner in thickness from a side distal from the end portion toward the other side near the end portion for engagement.

10. A driver head for a dental implant pick up and drive assembly of claim 8, wherein the end portion, including the driver head and the slant surface, is of a one piece design.

11. A driver head for a dental implant pick up and drive assembly of claim 8, wherein the slant surface of the driver head is spaced apart a distance (d) from the other side of the end portion of the at least one wall of the second circumferential wall to facilitate initial engagement of the slant surface and the round center portion of the first circumferential wall to facilitate initial engagement of the slant surface and the first wall portion of the dental implant.

12. A driver head for a dental implant pick up and drive assembly of claim 9, wherein the slant surface of the driver head is changeable with respect to its dimension, shape or curvature under a condition of being able to insert and interfere with the first wall portion of the dental implant.
